(19) United States
(12) Patent Application Publication
(10) Pub. No.: US 2008/0148630 A1
(43) Pub. Date: Jun. 26, 2008

(54) Methods and systems for growing plants using diffuse scattering illumination

(75) Inventors: Robert E. Ryan, Diamondhead, MS (US); George A. May, Slidell, LA (US)

Correspondence Address: CROWELL & MORING LLP;INTELLECTUAL PROPERTY GROUP, P.O. BOX 14300, WASHINGTON, DC, 20044-4300, US

(73) Assignee: Institute for Technology Development, Stennis Space Center, MS (US)

(21) Appl. No.: 11/641,651

(22) Filed: Dec. 20, 2006

(51) Int. Cl. A01G 9/00; A01G 9/20

(52) U.S. Cl. 47/17

(57) ABSTRACT

An artificial lighting environment is provided. The environment includes an enclosure having an internal growth chamber for containing plants. The enclosure includes an outer surface exposed to an external environment and an inner surface that is exposed to the internal growth chamber and that provides diffuse reflection. A light source illuminates the internal growth chamber, and the inner surface affects light from the light source incident on the inner surface so as to provide substantially uniform and diffuse illumination to plants in the internal growth chamber. This environment provides minimal contamination to the plants contained in the enclosure.

### FIELD OF THE INVENTION

The present invention relates generally to artificial illumination, and in particular, to using diffuse scattering illumination for growing plants.

### BACKGROUND

Light is a critical environmental condition, having significant effects on living organisms. In particular, light has consistent and direct effects on plants. For example, spatial variation in light irradiance on plants can affect plant growth and development. Indeed, the degree of plant growth variability is significantly influenced by light field spatial uniformity or the lack thereof.

Artificial light is often used for growing plants. Artificial light is used where natural light isn't available as well as to control undesirable variations occurring in natural illumination environments. To optimize plant growth under artificial illumination, several illumination characteristics should be considered. These characteristics include, for example, spectral content, irradiance or Photosynthetically Active Radiation (PAR) levels, spatial uniformity, shading potential, and efficiency.

To achieve optimal results, artificial lighting systems should provide spatially uniform light and promote energy efficiency. Artificial lighting systems should also maximize photon flux in the appropriate spectral range to satisfy plant photosynthesis needs. Plants typically require PAR levels between 400 and 700 nanometers for photosynthesis. In some cases, longer wavelengths (e.g., near infrared (NIR)) may be needed for healthy plant growth. To maximize photosynthetic activity, shading potential for natural light should be minimized over an entire plant area.

Several artificial lighting systems for growing plants exist. Traditionally, artificial lighting systems employed fluorescent, high pressure sodium and other conventional lighting technologies to illuminate plant canopies or suitable enclosures. Discrete light sources such as Light Emitting Diodes (LEDs), however, are replacing these traditional technologies. Because LEDs are directional in nature (i.e., they emit light in a specific direction), LEDs are typically arranged in arrays and placed above a plant canopy. To provide the required spectral distribution for optimal plant growth, different wavelength LEDs (e.g., blue and red) are often integrated into the array. In LED systems, the discrete LEDs are arranged into a pattern that produces uniform illumination with the proper spectral distribution.

Conventional artificial lighting systems are deficient in several aspects. For example, conventional systems often fail to provide a desirable intensity and quality of light so as to effectively minimize variations and maximize overall plant growth. These conventional lighting systems often lose efficiency by illuminating areas where there are no photosynthetic areas and the light is lost. In addition, the enclosures used by conventional systems may allow contamination (e.g., pests, diseases, etc.) of the plants. Conventional systems also fail to maximize efficiency. That is, they often fail to maximize growth for each energy unit of light and therefore fail to effectively reduce energy requirements.

In addition, for many plant varieties, array lighting (such as LED arrays) placed above a plant canopy produces large shadow fractions. These shadow fractions often reduce the amount of light available for photosynthesis. Shadowing from direct illumination can also limit the effectiveness of systems used to monitor a canopy or specific plant's health. Moreover, in cases where there is a desire for a large number of wavelengths, the design and fabrication of a lighting array, especially an LED array, can be complex and expensive.

### SUMMARY

Systems, apparatus, methods and articles of manufacture consistent with the present invention may obviate one or more of the above and/or other issues. In one example, systems, apparatus, methods and articles of manufacture are provided for using diffuse scattering illumination to optimize plant growth.

The present invention provides an artificial lighting system for growing plants that includes an enclosure having an internal growth chamber for containing plants. The enclosure has an outer surface that is exposed to an external environment and an inner surface that is exposed to the internal growth chamber and provides diffuse reflection. At least one light source illuminates the internal growth chamber, and the inner surface affects light from the at least one light source incident on the inner surface so as to provide substantially uniform and diffuse illumination to plants in the internal growth chamber.

The present invention also provides a method for growing plants. The method may comprise: enclosing a plant in a growth chamber; illuminating the growth chamber with light from a light source; and providing an inner surface of the growth chamber with at least one of a shape, a composition, and a texture such that the inner surface affects the light from the light source in a manner that provides a substantially uniform and diffuse illumination to the plant in the growth chamber.

Another artificial lighting system for growing plants includes means for containing plants, wherein the means for containing plants includes reflecting means exposed to the plants for providing diffuse reflection of light; and means for illuminating plants in the containing means, wherein the reflecting means manipulates light from the illuminating means to provide substantially uniform and diffuse illumination to the plants.

The present invention facilitates optimized and uniform plant growth. A desirable intensity and quality of light may be provided so as to effectively minimize variations and maximize overall plant growth. Available light may be maximized, thereby reducing the amount of light required and minimizing associated energy costs. Shadowing and contamination (pests, diseases, etc.), as well as the time required to achieve harvest-stage plants, may also be reduced. Additionally, uniform illumination of varying and complex enclosures is facilitated, which allows for effective plant stress imaging. Moreover, arrays for direct illumination are not required and various wavelengths of light may be mixed using multiple scattering, allowing for flexible and adaptable lighting.

The foregoing background and summary are not intended to be comprehensive, but instead serve to help artisans of ordinary skill understand implementations consistent with the present invention set forth in the appended claims. The foregoing background and summary are not intended to provide any independent limitations on the claimed invention or equivalents thereof.

### BRIEF DESCRIPTION OF THE DRAWINGS

The accompanying drawings show features of implementations consistent with the present invention and, together with the corresponding written description, help explain principles associated with the invention. In the drawings:

FIG. 1 illustrates an exemplary implementation of an artificial lighting system consistent with the present invention;

FIGS. 2A and 2B collaboratively illustrate an another implementation of an artificial lighting system consistent with the present invention;

FIG. 3 illustrates another implementation of an artificial lighting system consistent with the present invention;

FIG. 4 illustrates yet another implementation of an artificial lighting system consistent with the present invention; and

FIG. 5 illustrates an exemplary plant growth process consistent with the present invention.

### DETAILED DESCRIPTION

The following description refers to the accompanying drawings, in which, in the absence of a contrary representation, the same numbers in different drawings represent similar elements. The implementations set forth in the following description do not represent all implementations consistent with the claimed invention. Other implementations may be used and structural and procedural changes may be made without departing from the scope of present invention.

### Exemplary System

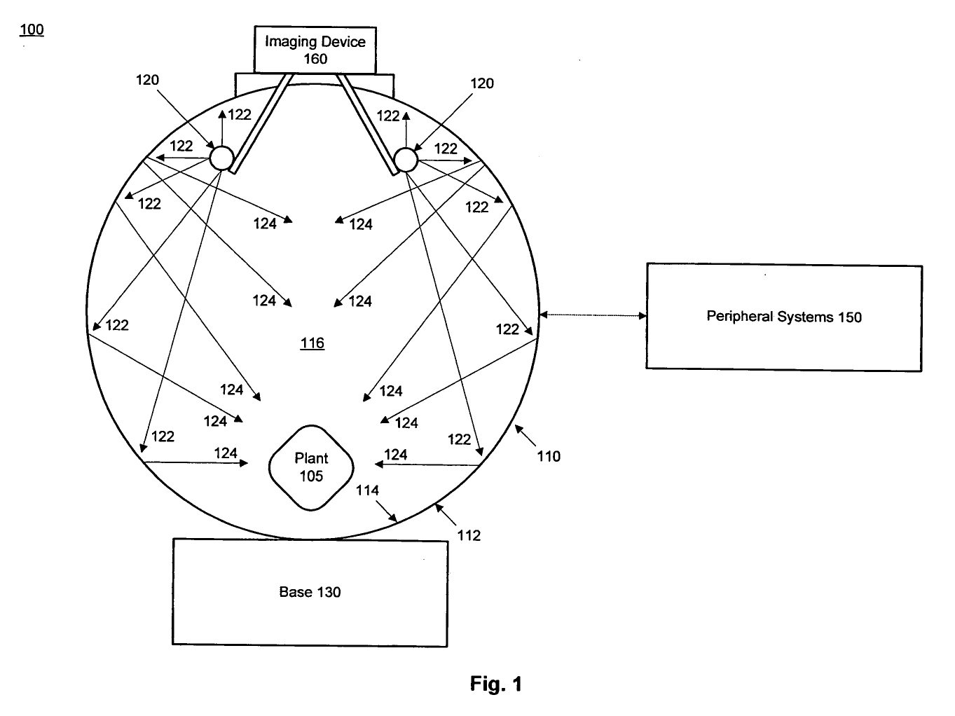

FIG. 1 illustrates an exemplary artificial lighting system 100 consistent with an implementation of the present invention. Artificial lighting system 100 may be used for growing one or more plants 105. As used herein, the term “plant” refers to any living organism capable of growth by way of light. The term plant includes, for example, any photosynthetic, eukaryotic, multicellular members of the Kingdom Plantae biological classification. The term plant also encompasses other types of living organisms, such as fungi and bacteria. As illustrated in FIG. 1, artificial lighting system 100 may comprise an enclosure 110, one or more light sources 120, a base 130, and an imaging device 160.

Enclosure 110 may include any suitable structure for containing or confining one or more plants 105 from an external environment. Enclosure 110 may be configured in a variety of shapes and sizes and may be formed from one or more natural, synthetic, and/or semi-synthetic materials, such as plastics, resins, fibreglass, metals, alloys, glass, acrylics, etc. Enclosure 110 may exhibit various textures and porosity depending on the requirements of the application.

Enclosure 110 may be configured so as to prevent contamination of plants 105. In one implementation, enclosure 110 may be of a suitable shape, size, texture, and porosity to keep plants 105 free of spores and other diseases. Enclosure 100 may be configured, for example, to allow for over pressuring above ambient with a filtered gas, dry air, etc. to minimize contamination from spores, insects, and/or diseases.

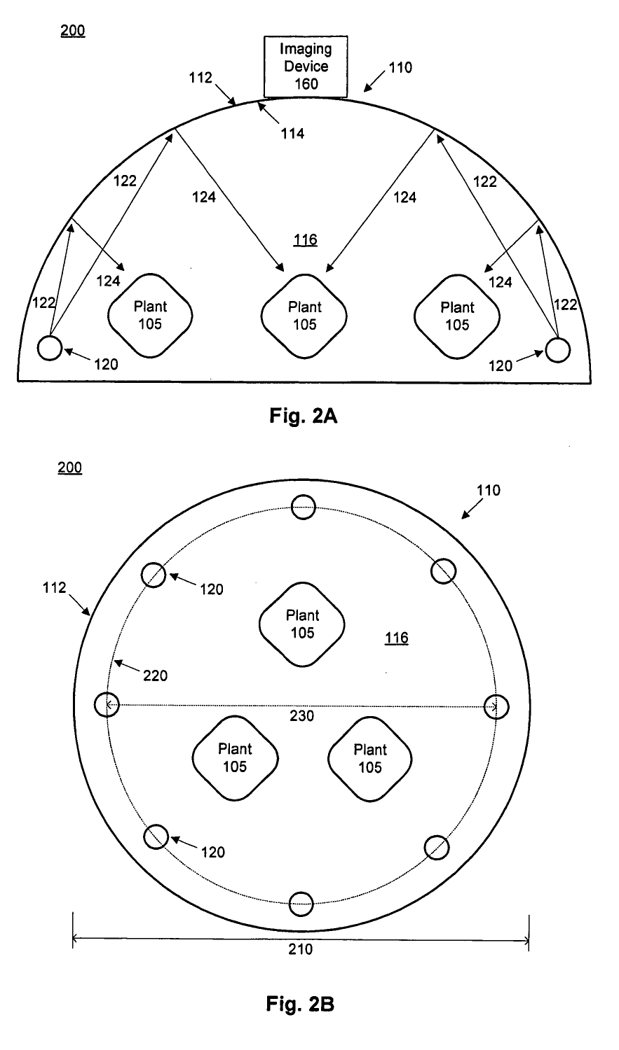

In one exemplary configuration, as illustrated in FIG. 1, enclosure 110 may be substantially spherical in shape with, for example, a diameter of approximately 3-ft, and may be formed of one or more plastic materials. Its configuration is not limited to what is shown in FIG. 1, and other shapes, sizes, and/or materials may be used. Such alternative configurations are discussed further below in connection with FIGS. 2A, 2B, 3, and 4.

Referring again to FIG. 1, enclosure 110 may include an outer surface 112 and an inner surface 114 and may provide a internal growth chamber 116 in which plants 105 may be located. Outer surface 112 may be exposed to the external environment, while inner surface 114 may be exposed to the growth chamber 116. As illustrated in FIG. 1, inner surface 114 may be of a similar shape to outer surface 112, but in alternative configurations, it may have a different shape. For example, outer surface 112 could be a box and inner surface 114 could be a sphere. Moreover, inner surface 114 could also be formed of a different material (e.g., plastic) than outer surface 112 (e.g., metal).

Inner surface 114 of enclosure 110 may be exposed to internal growth chamber 116 and may be configured to affect or manipulate light. For example, inner surface 114 may be configured to affect or manipulate light incident on the inner surface 114 (e.g., light 122 from light sources 120) so as to provide substantially uniform and diffuse illumination (e.g., illumination 124) to plants 105 within internal growth chamber 116. Inner surface 114 may have an appropriate shape (e.g., dome), composition, and/or texture such that the inner surface affects light from light sources 120 in a manner that provides the substantially uniform and diffuse illumination. In one configuration, inner surface 114 may include or be coated with highly diffuse reflective material (which could be natural, synthetic, and/or semisynthetic) to affect or manipulate light and provide such illumination. For example, inner surface 114 could include or be coated with suitable compounds (e.g., barium sulfate), thermoplastic or other resins (e.g., Spectralon™, and/or polymers. Inner surface 114 may be configured to provide an appropriate uniform and diffuse reflectance so as to provide a desired illumination to plants 105. Inner surface 114 may be configured so as to provide a diffuse reflectance between 95-99.9% over a range of 350-900 nm and to be spectrally flat to ± a few percent (e.g., 4%) over the range.

Inner surface 114 may reflect and scatter light at a multitude of angles, providing diffuse reflection. Thus, light rays incident on inner surface 114 (e.g., light 122) may be distributed by multiple scattering reflections such that the directionality of the light is minimized. In one configuration, inner surface 114 may exhibit near Lambertian reflectance (i.e., perfect angular uniform scattering of light). As a Lambertian reflector, inner surface 114 may provide a surface luminance or reflected intensity that is independent of the viewing angle, with the total reflected intensity decreasing according to Lambert's cosine law.

Inner surface 114 may also be configured to spatially mix various wavelengths of light originating from light source 120, and to recycle photons to produce a highly uniform illumination. The shape, texture, and/or composition of inner surface 114 may facilitate or influence the effectiveness of such mixing. In one example, inner surface 114 may be configured in a spherical or dome-like shape to facilitate effective spatial mixing of light. Other shapes may be appropriate as long as they can efficiently mix light from various sources. Inner surface 114 may, for example, facilitate nearly 100% spatial mixing of various wavelengths and produce illumination spatial uniformities better than 1%. Examples of such various wavelengths are discussed below in connection with light sources 120.

In certain implementations, enclosure 110 may be configured to minimize energy expenditure by maximizing plant growth for each energy unit of light. Enclosure 110 may be configured to efficiently use light available from light sources 120 and to encourage absorption of light only by plant tissue. For example, inner surface 114 or enclosure 110 may provide high reflectivity and cause photosynthetic surfaces of plants 105 to become dominant absorption surfaces. That is, inner surface 114 may substantially limit light loss to that which is attributable to plant photosynthetic surfaces. Plant tissue with weak absorption can be covered by reflective surfaces to magnify the effect.

Quantitatively, inner surface 114 may cause the amount of irradiance (i.e., the power of electromagnetic radiation at a plant surface per unit area) to approach the input power divided by the effective plant absorbing surface area. This effect can be observed by considering equations (1) and (2) below.

The irradiance H for any wavelength of light inside growth chamber 116 can be expressed by the following equation:

$$H = \frac{{Φ}_{I } ρ}{{A}_{S} ( 1 - ρ ( 1 - f ) )} \qquad ( 1 )$$

In the above equation, Φ_{I} is the input power at a specific wavelength, A_{S} is the surface area of the enclosure, ρ is the surface reflectance, and f is the fraction of power lost. As the reflectance approaches unity and the fraction of power lost is dominated by the plant surfaces, the irradiance approaches input power divided by the effective plant surface. In the case where the fraction of power lost (f) equals A_{P}/A_{S}→0 (i.e., f=A_{P}/A_{S}, and ρ approaches unity), where A_{P} is the effective plant area, then the irradiance H approaches the input power divided by effective plant surface as shown in the formula below.

$$H = \frac{{Φ}_{I}}{{A}_{P}} \qquad ( 2 )$$

As shown above, in a system with high reflectivity and limited losses other than the plant photosynthetic surfaces, the actual plant photosynthetic surfaces become the dominant absorption surfaces. In this fashion, the use of light can be maximized.

Referring again to FIG. 1, artificial lighting system 100 may include one or more light sources 120 that illuminate internal growth chamber 116. A light source 120 may include any mechanism for generating electromagnetic radiation (i.e., light) useful to plants 105, by way of various processes, such as thermal radiation (e.g., incandescence) or other radiation, emission, chemoluminescence, etc. Light sources 120 may also include various types of lights, such as incandescent lights, fluorescent lights, high-intensity discharge lamps, light-emitting diodes, etc.

Light sources 120 may generate various colors or wavelengths of electromagnetic radiation. In one configuration, they may generate Photosynthetically Active Radiation (PAR), which is the spectral range of light from 400 to 700 nanometers useful for photosynthesis. In addition or as an alternative, they may also generate light in wavelengths outside the PAR range, such as ultraviolet (UV) and near-infrared (NIR) wavelengths. Wavelengths outside the PAR range could be used for various purposes, such as to provide fluorescence, for vegetation health indices, and/or to facilitate healthy plant growth.

Light sources 120 may be situated relative to enclosure 110 so as to illuminate internal growth chamber 116. For example, as depicted in FIG. 1, light sources 120 may be situated inside enclosure 110 so as to illuminate internal growth chamber 116. Light sources 120 may be fixed inside enclosure 110 using suitable mounting techniques known in the art. Light sources 120 could alternatively be situated external to or outside enclosure 110 and provide illumination through one or more access ports (not shown) in enclosure 110. Additionally, one or more light sources 120 could be located inside enclosure 110 with one or more other light sources 120 located outside enclosure 110.

In certain configurations, light sources 120 may be arranged and/or include optional components to affect generated light. For example, light sources 120 may be baffled to minimize any direct illumination on plants 105.

The number and arrangement of light sources 120 are not limited to what is depicted in FIG. 1. System 100 may include any number of discrete light sources depending on the particular requirements of the application. All of the discrete light sources may be of similar structure and produce the same type of light, or the discrete light sources may be of varying structure and/or color and produce varying types of light. As an example, a first pair of light sources 120 may include LEDs that produce light in the PAR range while a second pair of light sources 120 may include tungsten halogen lamps that produce NIR light.

Light sources 120 may be automated and include one or more automation, control, and/or monitoring/diagnostic components. Each of a plurality of discrete light sources 120 may be independently and individually controllable and/or operable for monitoring. Alternatively, all of the light sources may be controllable and observable as a single system. In one configuration, light sources 120 may include one or more individually controllable and observable sets of lights, each set including one or more discrete light sources. One or more external or peripheral systems may facilitate monitoring and controlling light sources 120, as discussed further below in connection with peripheral systems 150.

As discussed above, inner surface 114 may spatially mix various wavelengths of light originating from a plurality of discrete light sources 120. Inner surface 114 may, for example, facilitate spatial mixing of light in the PAR range originating from certain discrete light sources and light in the NIR range.

In one exemplary configuration, as illustrated in FIG. 1, artificial lighting system 100 may include base 130. Base 130 may be configured to provide support for enclosure 110. For example, base 130 may serve as a supporting stand for enclosure 110. Base 130 may also provide support to plants 105. For example, base 130 may contain various soils, nutrients, and/or chemicals useful to plants 105. In such a configuration, base 130 may be integrated as part of enclosure 110. In addition, base 130 may include one or more moving parts and may provide access to internal growth chamber 116.

Consistent with the present invention, artificial lighting system 100 may include and/or be used in conjunction with one or more peripheral systems 150. Peripheral systems 150 may include one or more components suitable for be providing system 100 with monitoring and control functionality. For example, peripheral systems 150 may provide automatic and/or remote control and monitoring of components of lighting system 100, environmental conditions, and/or inputs (e.g., nutrients and chemicals) to plants 105. Peripheral systems 150 may include various hardware, software, and/or firmware components, including imagers, detectors, sensors, combinational logic, processors and microprocessors, storage facilities, I/O devices, networks (e.g., neural networks), communication devices, and/or other suitable components. In one configuration, peripheral systems 150 may include one or more multispectral and/or hyperspectral image sensor components for providing remotely sensed imagery.

Peripheral systems 150 may be configured to detect and analyze various components and/or conditions associated with artificial lighting system 100. For example, peripheral systems 150 may be configured to detect and analyze operational information (e.g., diagnostic and state information) associated with components of lighting system 100, such as light sources 120. Peripheral systems 150 may also be configured to detect and analyze conditions within growth chamber 116 and/or conditions associated with plant 105. Peripheral systems 150 may, for example, analyze various lighting conditions such as illumination levels, spectral content, spatial uniformity, PAR levels, shading, photon flux, reflectance, transmittance, absorbance, etc. Peripheral systems 150 may also analyze other conditions such as pH levels, oxygen and carbon dioxide levels, amounts of trace gases, temperature, humidity, aerosol levels, plant stress, biomass, etc.

Peripheral devices 150 may perform monitoring and control functionality using one or more algorithms, state machines, and/or processors. Peripheral devices 150 may perform control and monitoring functionality based on various information (e.g., lighting conditions within growth chamber 116) dynamically and automatically obtained by peripheral systems 150. The monitoring and control functionality could also be based on one or more commands received from a user or system. For example, a user may input commands to one or more components of peripheral devices 150 using a data processing system, such as a desktop computer.

In one configuration, peripheral systems 150 may be configured to monitor and control illumination levels and lighting mixtures in artificial lighting system 100. In such a configuration, peripheral systems 150 may include, among other components, one or more photodetectors (not shown). For example, peripheral systems 150 may include a single photodetector and a set of spectrally filtered photodetectors to monitor and control the illumination level as well as the lighting mixture.

Peripheral systems 150 may monitor and control actuation and/or modulation of light sources 120, as well as the various wavelengths provided by each light source. In one example, systems 150 may monitor and control light sources 120 in order to produce or effect changes in illumination levels, spectral content, spatial lighting patterns, and/or temporal lighting patterns within growth chamber 116. Peripheral systems 150 may be configured to effect a desirable intensity and quality of light using light sources 120 so as to effectively minimize variations and maximize overall plant growth.

The monitoring and control of lighting sources 120 may be based on detected lighting conditions and operational information. Alternatively, the monitoring and control of light sources 120 may occur independent of detected information and conditions. For example, light sources 120 may be actuated and modulated according to a pre-determined sequence, which may be pre-stored in a memory. A combination of these approaches could also be used.

In addition to illumination, peripheral systems 150 may be configured to control and effect changes to other conditions within growth chamber 116 and/or inputs to plants 105. For example, systems 150 may be configured to adjust pH levels, temperature, or humidity. Peripheral systems 150 could also control the administration of nutrients and chemicals to plants 105. In one configuration, systems 150 may examine various measured information and then identify and implement cultivation and/or remediation in order to optimize plant growth.

Consistent with one particular implementation, peripheral systems 150 may include or be part of an “expert system” or other knowledge-based system, which may, among other things, control illumination and the addition of plant inputs. Such an expert system may be trained to analyze and evaluate various conditions, for example, using one or more heuristic techniques. The expert system may control, for example, the spatial and temporal lighting pattern within the contained area, as well as the timing and allocation of plant inputs. An exemplary “expert system” is described in co-pending U.S. patent application Ser. No. 11/312,464, filed Dec. 21, 2005, entitled “Expert System for Controlling Plant Growth in a Contained Environment,” the entire disclosure of which is herein expressly incorporated by reference.

Imaging device 160 may collect images of plants 105. This device may include and/or leverage a variety of technologies including multispectral, hyperspectral, RAMAN, thermal, luminescence, photoacoustics, black and white or color digital cameras. Imaging device 160 may be used to detect stress of plants 105 and provide images of plant biomass. Device 160 can be programmed to capture plant images on a frequent basis that allows for time-lapse photography of the growing plant. Detection of plant stresses and biomass measurements from device 160 may be used to improve plant growth. Consistent with one particular implementation, device 160 (or information from device 160) may include or be used in conjunction with an “expert system” or other knowledge-based system. Such an “expert system” is described in co-pending U.S. patent application Ser. No. 11/312,464, filed Dec. 21, 2005, entitled “Expert System for Controlling Plant Growth in a Contained Environment.”

As discussed above, artificial lighting system 100 can be configured in various shapes and sizes with various lighting arrangements. FIGS. 2A and 2B collaboratively illustrate an artificial lighting system 200, which represents one alternative configuration of artificial lighting system 100.

FIG. 2A illustrates a side view of system 200. As illustrated in FIG. 2A, enclosure 110 may be substantially dome shaped. Enclosure 110 of system 200 may include inner and outer surfaces (112, 114) and form growth chamber 116. As in system 100, enclosure 110 of system 200 may be configured to affect or manipulate light incident on inner surface 114 (e.g., light 122) so as to provide substantially uniform and diffuse illumination (e.g., light 124) to plants 105 within internal growth chamber 116.

FIG. 2B illustrates a top or aerial view of system 200. As illustrated in FIG. 2B, the base portion of dome-shaped enclosure 110 may substantially circular and flat having a diameter 210 of, for example, 3 ft. Light sources 120 may include a plurality of discrete light sources (e.g., LEDs) arranged in a ring configuration 220 around the perimeter of enclosure 110 of system 200. The ring of lights may have a diameter 230 slightly smaller (e.g., 1 ft) than diameter 210 of enclosure 110. The ring of lights may be arranged such that light generated from the light sources 120 is directed upward and such that the light uniformly illuminates the hemisphere and is allowed to bounce around before striking a large flat surface on which plants 105 may be placed.

The number and arrangement of lights 120 are not limited to the depiction in FIG. 2. The illustrated ring configuration 220 may include a greater or fewer number of discrete light sources than what is depicted in FIG. 2. The lights could also be arranged differently than is shown.

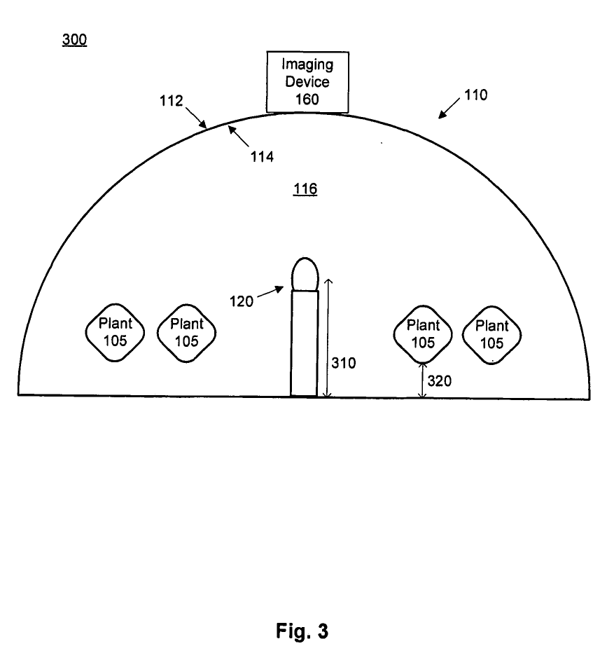

FIG. 3 illustrates an artificial lighting system 300, which represents yet another exemplary configuration of artificial lighting system 100 consistent with the present invention. As illustrated in FIG. 3, artificial lighting system 300 may include one or more light sources 120 arranged within enclosure 120 at a height 310 that is higher than a height 320 of plants 105. In system 300, light source(s) 120 may be coupled to the base of enclosure 110 and/or may be situated at the center (as illustrated) or around the periphery of enclosure 110, which may be dome-shaped. Light source(s) 120 in system 300 may be pointed towards the inner surface 114 of enclosure 110, which affects or manipulates light so as to provide substantially uniform and diffuse illumination to plants 105 within growth chamber 116.

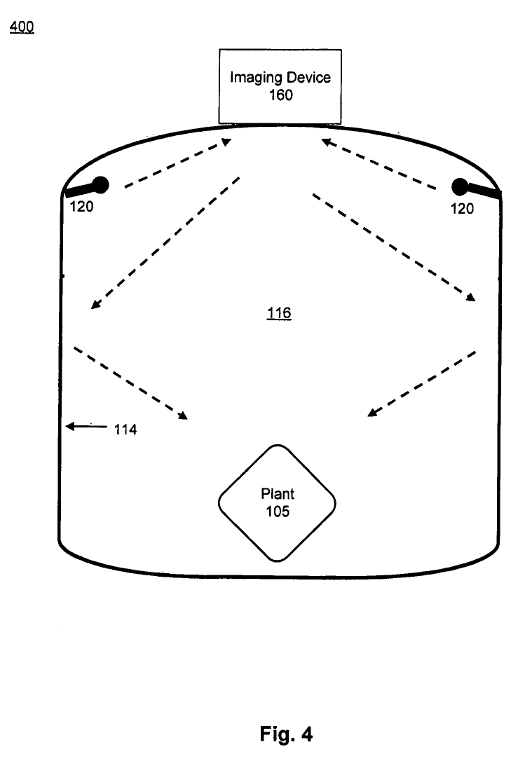

FIG. 4 illustrates an artificial lighting system 400, which represents yet another exemplary configuration of artificial lighting system 100 consistent with the present invention. As illustrated in FIG. 4, artificial lighting system 400 may include one or more light sources 120 arranged at the base of the dome. Examples of light sources 120 include a ring of LEDs, single LEDs, or any other light source. Light sources 120 are pointed at the dome and inner surface 114, which affects or manipulates light so as to provide substantially uniform and diffuse illumination to plants 105 within growth chamber 116.

For purposes of explanation only, certain aspects of the present invention are described herein with reference to the elements and components illustrated in FIGS. 1, 2A, 2B, 3, and 4. The illustrated elements and their configurations are exemplary only. Other variations in the number and arrangement of components are possible, consistent with the present invention. Further, depending on the implementation, certain illustrated elements may be absent and/or additional components not illustrated may be present. In addition, some or all of the functionality of the illustrated components may overlap and/or exist in a fewer or greater number of components than what is illustrated.

### Exemplary Plant Growth Process

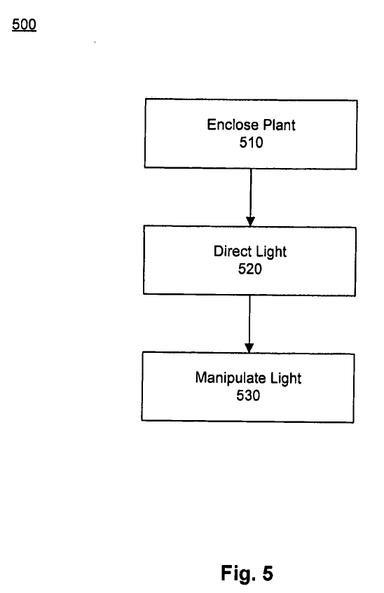

FIG. 5 illustrates an exemplary process 500 of growing plants using artificial lighting consistent with the present invention. As illustrated, process 500 may comprise: enclosing a plant in a growth chamber (510); directing light into the growth chamber (520); and manipulating the light so as to provide a substantially uniform and diffuse illumination to the plant in the growth chamber (530).

Process 500 may begin with enclosing a plant in a growth chamber (510). For example, plant 105 may be enclosed within internal growth chamber 116 of artificial lighting system 100 via one or more access ports. Once the plant is enclosed, light may be directed into the growth chamber (520). This may involve installing and activating one or more discrete light sources so as to illuminate growth chamber 116. This may also involve individually and/or collaboratively modulating and/or otherwise controlling the light sources so as to achieve certain objectives, such as desired spectral contents, illumination levels, power consumption levels, energy efficiencies, etc. In certain embodiments, directing light into the growth chamber may involve installing, operating, and/or otherwise interacting with one or more peripheral systems 150.

Once light is directed into the growth chamber, the light may be manipulated so as to provide a substantially uniform and diffuse illumination to the plant in the growth chamber (530). This manipulation may be achieved by way of enclosure 110. For example, enclosure 100 may be configured such that inner surface 114 manipulates light and provides the uniform and diffuse illumination. This could also involve appropriately monitoring and adjusting the uniformity and diffuseness of light within growth chamber 116 to achieve certain objectives, such as those mentioned above. The manipulation stage may, in certain embodiments, involve interacting with one or more peripheral systems 150.

In certain embodiments, process 500 may also include various supplemental sub-processes and stages. For example, process 500 may include various monitoring processes that occur at various times during the process. Such monitoring could include monitoring plant stress levels, conditions within the growth chamber, conditions external to the growth chamber, levels of plant inputs, etc. In addition to monitoring, process 500 may also include, for example, performing various calculations, executing algorithms, receiving and processing user and other inputs, recommending and effecting inputs to plants and various remediation measures, and/or controlling various systems and components.

FIG. 5 is consistent with exemplary implementations of the present invention. The sequence of events described in connection with FIG. 5 is exemplary and not intended to be limiting. Other steps may be used, and even with those depicted in FIG. 5, the particular order of events may vary without departing from the scope of the present invention. Further, the illustrated steps may overlap and/or may exist in fewer or greater steps. Moreover, certain steps may not be present and additional steps may be implemented in the illustrated method. The illustrated steps may also be modified without departing from the scope of the present invention.

### Exemplary Applications

The following description is intended merely to introduce some possible benefits and applications of the present invention. It is not intended to be a comprehensive list of all possible benefits and applications or of all details and variations of those benefits and applications described. In addition, the following description is not intended to provide any independent limitations on the claimed invention or its equivalents.

Plant Growth Facilities

A plant growth facility (e.g., a green house) typically provides a confined space in which desirable environmental conditions for plant growth can be maintained. To be effective, plant growth facility designs must satisfy at least the fundamental water, air, and light requirements for plant growth and survival. Incorporating uniform and diffuse illumination consistent with the present invention to plant growth facility designs could yield at least some of the benefits discussed above.

Tissue Culture Propagation

Tissue culture involves the propagation of plant and animal cells through the placement of small amounts of tissue in an artificial environment. A plant would respond to tissue culture if a suitable formula and process were developed for its culture. For plant tissue culture, a portion of the plant (e.g., stem, root, leaf, bud, single cell, etc.) would be placed in a test tube or other suitable structure. The portion of the plant would form plantlets, given a sterile environment and a balanced nutrient medium. These plantlets would multiply indefinitely if given proper care and could then be taken out of the tissue culture environment and planted normally. Using tissue culture, the plant environment can be controlled and optimized such that all of the plants from the tissue culture are identical for a particular desired quality, such as resistance to plant diseases or production of a plant chemical.

Incorporating aspects of the present invention to tissue culture processes may benefit tissue culture in a variety of ways. First, it could accelerate the growth of plantlets, which would reduce propagation time and expense. Second, it could increase the uniformity of tissue being cultured, thus providing more desirable plants. Third, it could eliminate or reduce contamination that may occur in current propagation processes. Conducting tissue culture propagation in a sphere or other contained configuration (e.g., cave, bunker, balloon, etc.) that would allow for implementation of aspects of the present invention could minimize or even eliminate exposure to external contaminants. Such an enclosed environment could allow for the over pressuring slightly above ambient with a filtered gas, dry air, etc. during the plant introduction and during the plant growth phases to minimize the introduction of spores.

Biopharming or Molecular Farming

Plants are frequently used to produce pharmaceuticals. Often, specific proteins grown in plants (e.g., tobacco, sweet potatoes, etc.) are extracted to produce various pharmaceutical products. Growing these protein-specific plants on the Earth's surface, however, has raised considerable concern. Incorporating aspects of the present invention to biopharming techniques could alleviate much of this concern. Aspects of the present invention could provide an alternative approach by growing in an environment contained above the Earth's surface or below the Earth's surface. As an example, biopharming could be carried out in a salt dome where plants are grown on stacked trays and the dome is configured to allow implementation of aspects of the present invention.

The foregoing description is not intended to be limiting. The foregoing description does not represent a comprehensive list of all possible implementations consistent with the present invention or of all possible details and variations of the implementations described. Those skilled in the art will understand how to implement the invention in the appended claims in many other ways, using equivalents and alternatives that do not depart from the scope of the following claims.

What is claimed is:

1. An artificial lighting system for growing plants, the system comprising:
an enclosure having an internal growth chamber for containing plants, the enclosure having an outer surface that is exposed to an external environment, and an inner surface that is exposed to the internal growth chamber and provides diffuse reflection; and
at least one light source to illuminate the internal growth chamber, wherein the inner surface affects light from the at least one light source incident on the inner surface so as to provide substantially uniform and diffuse illumination to plants in the internal growth chamber.

2. The system of claim 1, wherein the enclosure has a geometry that provides substantially uniform and diffuse illumination.

3. The system of claim 2, wherein the enclosure is configured with a dome type geometry.

4. The system of claim 2, wherein the enclosure includes at least one of a substantially spherical enclosure and a substantially hemispherical enclosure.

5. The system of claim 1, wherein the inner surface has at least one of a composition, a shape, and a texture that provides a substantially Lambertian diffuse reflectance, such that luminance of the inner surface is independent of viewing angle and such that directionality associated with the light from the at least one light source is minimized.

6. The system of claim 1, wherein the inner surface includes a surface coated with reflective material.

7. The system of claim 6, wherein the reflective material includes barium sulfate.

8. The system of claim 1, wherein the inner surface provides a diffuse reflectance between 95 percent and 99.9 percent over a range of 350 nanometers to 900 nanometers.

9. The system of claim 1, wherein the at least one light source comprises a light emitting diode.

10. The system of claim 1, wherein the at least one light source includes a plurality of discrete light sources that are individually controllable and individually operable to modulate.

11. The system of claim 10, wherein the plurality of discrete light sources produce a plurality of wavelengths of light, and wherein the inner surface mixes the plurality of wavelengths to provide the substantially uniform and diffuse illumination.

12. The system of claim 11, wherein at least one of the plurality of light sources produces a first wavelength of light in a range of 400-700 nanometers and at least one other of the plurality of light sources produces a second wavelength of light in a near-infrared range.

13. The system of claim 10, wherein the plurality of discrete light sources are arranged in a ring configuration.

14. The system of claim 1, further comprising at least one of a device for monitoring plant stress and biomass, a device for monitoring an environmental condition within the internal growth chamber, and a device for capturing images of plants within the internal growth chamber.

15. The system of claim 1, further comprising at least one control device configured to control environmental conditions within the growth chamber.

16. A method of growing plants using artificial lighting, the method comprising:
enclosing a plant in a growth chamber;
illuminating the growth chamber with light from a light source; and
providing an inner surface of the growth chamber with at least one of a shape, a composition, and a texture such that the inner surface affects the light from the light source in a manner that provides a substantially uniform and diffuse illumination to the plant in the growth chamber.

17. The method of claim 16, wherein illuminating the growth chamber comprises directing a plurality of wavelengths of light into the growth chamber, and wherein the inner surface mixes the plurality of wavelengths of light.

18. The method of claim 17, further comprising:
individually controlling and modulating the plurality of wavelengths of light.

19. The method of claim 16, further comprising:
monitoring a stress level of the plant using a monitoring device coupled to the growth chamber.

20. The method of claim 16, further comprising:
minimizing contamination to the plants.

21. The method of claim 16, wherein the providing stage comprises accelerating plant growth to minimize propagation time.

22. An artificial lighting system for growing plants, the system comprising:
means for containing plants, wherein the means for containing plants includes reflecting means exposed to the plants for providing diffuse reflection of light; and
means for illuminating plants in the containing means, wherein the reflecting means manipulates light from the illuminating means to provide substantially uniform and diffuse illumination to the plants.

23. The system of claim 22, wherein the illuminating means includes means for generating a plurality of wavelengths of light

24. The system of claim 23, wherein the reflecting means includes means for mixing the plurality of wavelengths of light.

25. The system of claim 23, further comprising means for individually controlling and modulating the plurality of wavelengths of light.

26. The system of claim 22, wherein the means for containing plants includes means for maximizing the plant growth for each energy unit of light.

27. The system of claim 22, wherein the reflecting means manipulates light to provide a light uniformity at a fraction of a percent.

28. The system of claim 22, wherein the means for containing plants facilitates plant stress and plant biomass imaging.
